(19) United States
(12) Patent Application Publication
(10) Pub. No.: US 2026/0078858 A1
(43) Pub. Date: Mar. 19, 2026

(54) DAMPENING DEVICE AND METHODS FOR SMOOTHING PULSATILE FLUID FLOW

(71) Applicant: BOSTON SCIENTIFIC SCIMED, INC., Maple Grove, MN (US)

(72) Inventors: Jessica Williams, Marlborough, MA (US); Cassandra Anne Hailson, Marlborough, MA (US); Troy Velazquez, Salem, NH (US)

(73) Assignee: BOSTON SCIENTIFIC SCIMED, INC., Maple Grove, MN (US)

(21) Appl. No.: 19/330,725

(22) Filed: Sep. 16, 2025

Related U.S. Application Data
(60) Provisional application No. 63/695,612, filed on Sep. 17, 2024.

(51) Int. Cl. F16L 55/027

(52) U.S. Cl. CPC F16L 55/02754

(57) ABSTRACT

A dampening device includes a housing including an inlet and an outlet, and a section of compliant tubing extending through the housing between the inlet and the outlet. A first portion of the housing is movable relative to a second portion of the housing to vary fluid flow characteristics within the section of compliant tubing. A dampening device includes a housing defining an interior volume, wherein the housing includes an inlet and an outlet, and an actuation mechanism configured to change the interior volume thereby changing fluid flow characteristics through the housing. A method of smoothing a pulsatile fluid flow includes coupling the dampening device to an inflow line, activating the fluid pump, wherein the section of compliant tubing expands within the housing to smooth out the pulsatile fluid flow, and selectively moving a first portion of the housing relative to a second portion to vary fluid flow characteristics.

### CROSS-REFERENCE TO RELATED APPLICATIONS

The application claims the benefit of U.S. Provisional Patent Application Ser. No. 63/695,612, filed on Sep. 17, 2024, the disclosure of which is incorporated herein by reference.

### TECHNICAL FIELD

The disclosure relates generally to medical devices and more particularly to a dampening device for use with a fluid management system comprising a fluid pump producing a pulsatile fluid flow and methods for smoothing a pulsatile fluid flow produced by a fluid pump.

### BACKGROUND

A wide variety of medical devices have been developed for medical use and/or for use with medical fluid management systems. These devices are manufactured by any one of a variety of different manufacturing methods and may be used according to any one of a variety of methods. There is an ongoing need to provide alternative medical devices as well as alternative methods for manufacturing and/or using medical devices.

### SUMMARY

In one example, a dampening device for use with a fluid management system comprising a fluid pump producing a pulsatile fluid flow may comprise a housing comprising an inlet and an outlet, and a section of compliant tubing extending through the housing between the inlet of the housing and the outlet of the housing. A first portion of the housing may be movable relative to a second portion of the housing to vary fluid flow characteristics within the section of compliant tubing.

In addition, or alternatively, to any example disclosed herein, the section of compliant tubing is configured to smooth oscillations in fluid flow rate of fluid flowing through the section of compliant tubing.

In addition, or alternatively, to any example disclosed herein, the first portion of the housing is movable between a first position spaced apart from the section of compliant tubing and a second position disposed immediately adjacent the section of compliant tubing.

In addition, or alternatively, to any example disclosed herein, in the second position, the first portion of the housing prevents radial expansion of the section of compliant tubing in response to fluid flow oscillations therein.

In addition, or alternatively, to any example disclosed herein, the section of compliant tubing is an inflow line of the fluid management system extending between the fluid pump and an endoscope.

In addition, or alternatively, to any example disclosed herein, the section of compliant tubing is disposed inline with an inflow line of the fluid management system extending between the fluid pump and an endoscope.

In addition, or alternatively, to any example disclosed herein, the first portion of the housing is a side wall extending between a first end wall of the housing and a second end wall of the housing.

In addition, or alternatively, to any example disclosed herein, the side wall of the housing forms a radially movable iris surrounding the section of compliant tubing.

In addition, or alternatively, to any example disclosed herein, and in another example, a dampening device for use with a fluid management system comprising a fluid pump producing a pulsatile fluid flow may comprise a housing defining an interior volume, wherein the housing comprises an inlet and an outlet, and an actuation mechanism configured to change the interior volume thereby changing fluid flow characteristics through the housing.

In addition, or alternatively, to any example disclosed herein, the actuation mechanism is configured to smooth oscillations in fluid flow rate of fluid flowing through the housing by changing the interior volume.

In addition, or alternatively, to any example disclosed herein, the actuation mechanism is configured to change the interior volume in response to fluid pressure.

In addition, or alternatively, to any example disclosed herein, the actuation mechanism is configured to change the interior volume with each pressure pulse produced by the fluid pump.

In addition, or alternatively, to any example disclosed herein, the actuation mechanism is configured to change the interior volume at a frequency equal to a frequency of the fluid pump.

In addition, or alternatively, to any example disclosed herein, the frequency of the actuation mechanism is phase shifted from the frequency of the fluid pump.

In addition, or alternatively, to any example disclosed herein, the housing is configured such that fluid pressure within the interior volume is prevented from deforming the housing.

In addition, or alternatively, to any example disclosed herein, a first portion of the housing is movable relative to a second portion of the housing to change the interior volume.

In addition, or alternatively, to any example disclosed herein, and in another example, a method of smoothing a pulsatile fluid flow produced by a fluid pump may comprise: coupling a dampening device to an inflow line extending downstream from the fluid pump, wherein the dampening device comprises a housing comprising an inlet and an outlet, and a section of compliant tubing extending through the housing between the inlet of the housing and the outlet of the housing; activating the fluid pump, thereby causing the pulsatile fluid flow to flow through the inflow line, wherein the section of compliant tubing radially expands within the housing to smooth out the pulsatile fluid flow; and selectively moving a first portion of the housing relative to a second portion of the housing to vary fluid flow characteristics within the section of compliant tubing.

In addition, or alternatively, to any example disclosed herein, selectively moving the first portion of the housing relative to the second portion of the housing comprises moving the first portion of the housing against an outer surface of the section of compliant tubing.

In addition, or alternatively, to any example disclosed herein, moving the first portion of the housing against the outer surface of the section of compliant tubing prevents the section of compliant tubing from radially expanding within the housing.

In addition, or alternatively, to any example disclosed herein, the housing surrounds the section of compliant tubing.

The above summary of some embodiments, aspects, and/or examples is not intended to describe each disclosed embodiment or every implementation of the present disclosure. The figures and the detailed description more particularly exemplify aspects of these embodiments.

### BRIEF DESCRIPTION OF THE DRAWINGS

The disclosure may be more completely understood in consideration of the following detailed description in connection with the accompanying drawings, in which:

FIG. 1 illustrates selected aspects of a system comprising a dampening device according to the disclosure;

FIGS. 2-3 schematically illustrate selected aspects of a dampening device;

FIG. 3A schematically illustrates selected aspects of an alternative configuration of the dampening device of FIGS. 2-3;

FIGS. 4-5 schematically illustrate selected aspects of a dampening device; and

FIGS. 6-7 illustrate selected characteristics of an example configuration of the dampening device of the disclosure.

While aspects of the disclosure are amenable to various modifications and alternative forms, specifics thereof have been shown by way of example in the drawings and will be described in detail. It should be understood, however, that the intention is not to limit aspects of the disclosure to the particular embodiments described. On the contrary, the intention is to cover all modifications, equivalents, and alternatives falling within the spirit and scope of the disclosure.

### DETAILED DESCRIPTION

The following description should be read with reference to the drawings, which are not necessarily to scale and/or which may include changes of scale therein, wherein like reference numerals indicate like elements throughout the several views. The detailed description and drawings are intended to illustrate but not limit the disclosure. Those skilled in the art will recognize that the various elements described and/or shown may be arranged in various combinations and configurations without departing from the scope of the disclosure. The detailed description and drawings illustrate example embodiments of the disclosure.

For the following defined terms, these definitions shall be applied, unless a different definition is given in the claims or elsewhere in this specification.

All numeric values are herein assumed to be modified by the term “about,” whether or not explicitly indicated. The term “about”, in the context of numeric values, generally refers to a range of numbers that one of skill in the art would consider equivalent to the recited value (e.g., having the same function or result). In many instances, the term “about” may include numbers that are rounded to the nearest significant figure. Other uses of the term “about” (e.g., in a context other than numeric values) may be assumed to have their ordinary and customary definition(s), as understood from and consistent with the context of the specification, unless otherwise specified.

The recitation of numerical ranges by endpoints includes all numbers within that range, including the endpoints (e.g., 1 to 5 includes 1, 1.5, 2, 2.75, 3, 3.80, 4, and 5).

Although some suitable dimensions, ranges, and/or values pertaining to various components, features and/or specifications are disclosed, one of skill in the art, incited by the present disclosure, would understand desired dimensions, ranges, and/or values may deviate from those expressly disclosed.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise. It is to be noted that to facilitate understanding, certain features of the disclosure may be described in the singular, even though those features may be plural or recurring within the disclosed embodiment(s). Each instance of the features may include and/or be encompassed by the singular disclosure(s), unless expressly stated to the contrary. For example, a reference to one feature may be equally referred to all instances and quantities beyond one of said feature unless clearly stated to the contrary. As such, it will be understood that the following discussion may apply equally to any and/or all components for which there are more than one within the device, etc. unless explicitly stated to the contrary.

Relative terms such as “proximal”, “distal”, “advance”, “retract”, variants thereof, and the like, may be generally considered with respect to the positioning, direction, and/or operation of various elements relative to a user/operator/manipulator of the device, wherein “proximal” and “retract” indicate or refer to closer to or toward the user and “distal” and “advance” indicate or refer to farther from or away from the user. In some instances, the terms “proximal” and “distal” may be arbitrarily assigned to facilitate understanding of the disclosure, and such instances will be readily apparent to the skilled artisan. Other relative terms, such as “upstream”, “downstream”, “inflow”, and “outflow” refer to a direction of fluid flow within a lumen, such as a body lumen, a blood vessel, or within a device. Still other relative terms, such as “axial”, “circumferential”, “longitudinal”, “lateral”, “radial”, etc. and/or variants thereof generally refer to direction and/or orientation relative to a central longitudinal axis of the disclosed structure or device.

The term “extent” may be understood to mean the greatest measurement of a stated or identified dimension, unless the extent or dimension in question is preceded by or identified as a “minimum”, which may be understood to mean the smallest measurement of the stated or identified dimension. For example, “outer extent” may be understood to mean an outer dimension, “radial extent” may be understood to mean a radial dimension, “longitudinal extent” may be understood to mean a longitudinal dimension, etc. Each instance of an “extent” may be different (e.g., axial, longitudinal, lateral, radial, circumferential, etc.) and will be apparent to the skilled person from the context of the individual usage. Generally, an “extent” may be considered a greatest possible dimension measured according to the intended usage, while a “minimum extent” may be considered a smallest possible dimension measured according to the intended usage. In some instances, an “extent” may generally be measured orthogonally within a plane and/or cross-section, but may be, as will be apparent from the particular context, measured differently-such as, but not limited to, angularly, radially, circumferentially (e.g., along an arc), etc.

The terms “monolithic” and “unitary” shall generally refer to an element or elements made from or consisting of a single structure or base unit/element. A monolithic and/or unitary element shall exclude structure and/or features made by assembling or otherwise joining multiple discrete structures or elements together.

It is noted that references in the specification to “an embodiment”, “some embodiments”, “other embodiments”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to implement the particular feature, structure, or characteristic in connection with other embodiments, whether or not explicitly described, unless clearly stated to the contrary. That is, the various individual elements described below, even if not explicitly shown in a particular combination, are nevertheless contemplated as being combinable or arrangeable with each other to form other additional embodiments or to complement and/or enrich the described embodiment(s), as would be understood by one of ordinary skill in the art.

For the purpose of clarity, certain identifying numerical nomenclature (e.g., first, second, third, fourth, etc.) may be used throughout the description and/or claims to name and/or differentiate between various described and/or claimed features. It is to be understood that the numerical nomenclature is not intended to be limiting and is exemplary only. In some embodiments, alterations of and deviations from previously used numerical nomenclature may be made in the interest of brevity and clarity. That is, a feature identified as a “first” element may later be referred to as a “second” element, a “third” element, etc. or may be omitted entirely, and/or a different feature may be referred to as the “first” element. The meaning and/or designation in each instance will be apparent to the skilled practitioner.

Additionally, it should be noted that in any given figure, some features may not be shown, or may be shown schematically, for clarity and/or simplicity. Additional details regarding some components and/or method steps may be illustrated in other figures in greater detail. It is noted that some reference numbers may be discussed but are not expressly shown with respect to a particular figure. Reference numbers discussed but not expressly shown may be shown in other figures. Similarly, some reference numbers shown but not expressly discussed may be discussed with respect to other figures herein. The systems, devices, and/or methods disclosed herein may provide a number of desirable features and benefits as described in more detail below.

Fluid management systems for endourological procedures can deliver fluid to patient anatomy via a peristaltic pump. Peristaltic pumps are beneficial as they prevent fluid from encountering exposed pump components, and their design prevents backflow without the use of valves. However, the peristaltic mechanism induces oscillations into the fluid flow, which may result in unwanted consequences in endourological procedures, such as inconsistent visualization. It is possible to dampen oscillations by introducing compliance into the flow path. Some known dampeners rely upon a compressible gas or a flexible membrane to reduce oscillations. Although dampeners may reduce flow oscillations, they also decrease flow responsiveness by prolonging the time required to build pressure within the system. Existing fluid management systems and/or dampening devices may have certain advantages and/or disadvantages. There is an ongoing need for alternative fluid management systems and/or dampening devices and/or methods of smoothing pulsatile fluid flow.

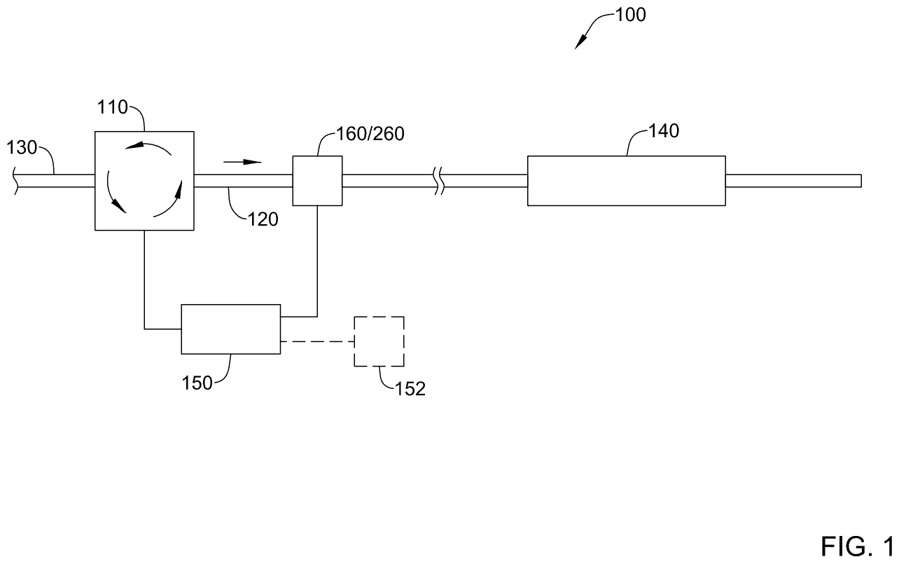

FIG. 1 illustrates selected aspects of a system 100. In some embodiments, the system 100 may comprise and/or may be a fluid management system. In some embodiments, the system 100 and/or the fluid management system may comprise a fluid pump 110, which may be a peristaltic fluid pump, configured to and/or capable of producing a pulsatile fluid flow. In some embodiments, the system 100 may comprise an inflow line 120 extending downstream from the fluid pump 110. In some embodiments, the system 100 may comprise a supply line 130 extending upstream from the fluid pump 110, such as to a fluid supply source (not shown), a fluid reservoir, etc. In some embodiments, the system 100 may comprise a medical device, such as an endoscope 140, configured for insertion into a patient and/or configured to deliver fluid (e.g., saline, medicine, blood, etc.) to the patient. For simplicity, the endoscope 140 is shown schematically. Some non-limiting examples of a fluid management system, which may include and/or describe an example endoscope which may be used with the instant disclosure may be found in U.S. Patent Application Publication No. 2018/0361055, U.S. Patent Application Publication No. 2021/0236728, and/or U.S. Patent Application Publication No. 2022/0370706, the entire contents of which are incorporated herein by reference. In some embodiments, the system 100 and/or the fluid management system may comprise a controller 150. In some embodiments, the controller 150 may be operably coupled to and/or may be in electronic communication with the fluid pump 110 and/or the endoscope 140.

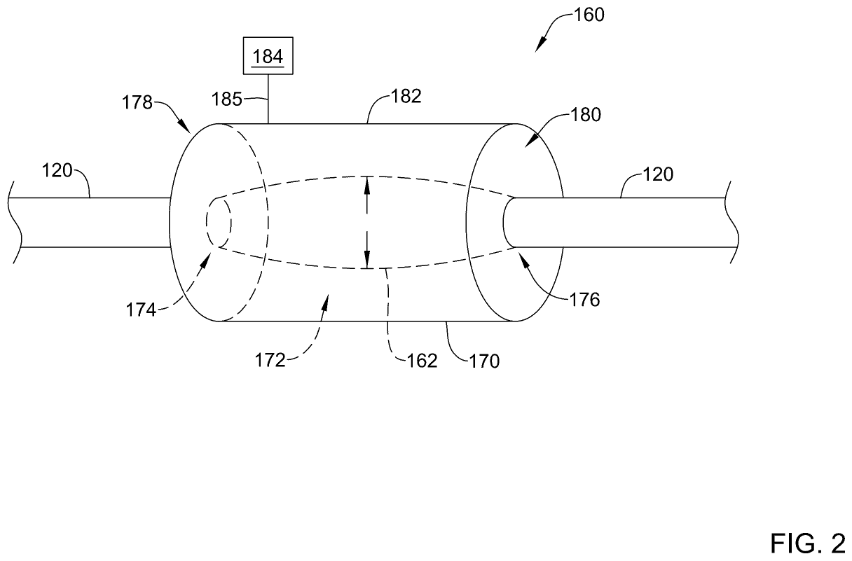

In some embodiments, the system 100 may comprise a dampening device 160/260 for use with the system 100 and/or a fluid management system comprising a fluid pump 110 producing a pulsatile fluid flow. In some embodiments, the controller 150 may be operably coupled to and/or may be in electronic communication with the dampening device 160/260. In some embodiments, the system 100 may optionally comprise an activation switch 152 operably coupled to and/or may be in electronic communication with the controller 150. Alternatively, the activation switch 152 may be operably coupled to and/or may be in electronic communication with the fluid pump 110 and/or the endoscope 140. The activation switch 152 may take one or more various forms, such as but not limited to, a foot pedal, a button, a lever, a toggle switch, a voice recognition device, etc. FIG. 1 illustrates the dampening device 160/260 in a highly schematic manner, and selected aspects of the dampening device 160/260 are shown in more detail in FIGS. 2-5.

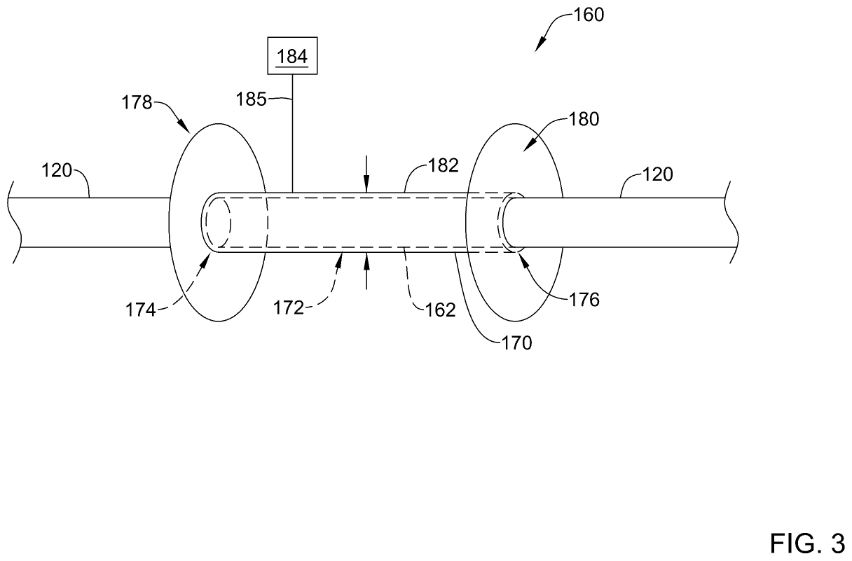

FIGS. 2-3 illustrates selected aspects of the dampening device 160. In some embodiments, the dampening device 160 may comprise a housing 170. The housing 170 may define an interior volume 172 and/or an interior space disposed therein. In some embodiments, the housing 170 may comprise an inlet 174 and an outlet 176. In some embodiments, the housing 170 may comprise a first end wall 178 and a second end wall 180. In some embodiments, the second end wall 180 may be disposed generally opposite the first end wall 178. Other configurations are also contemplated. In some embodiments, the inlet 174 may be disposed in and/or may extend through the first end wall 178. In some embodiments, the outlet 176 may be disposed in and/or may extend through the second end wall 180.

In some embodiments, the housing 170 may comprise a side wall 182 extending between the first end wall 178 and the second end wall 180. In some embodiments, the side wall 182 may extend from the first end wall 178 to the second end wall 180. In some embodiments, the side wall 182 may be substantially annular in shape and/or may extend along and/or around a circumference of the housing 170. As such, the housing 170 may be cylindrical in shape. Other shapes and/or configurations are also contemplated. In some embodiments, the housing 170 may comprise a plurality of side walls extending between the first end wall 178 and the second end wall 180 and/or extending from the first end wall 178 to the second end wall 180. In one non-limiting example, the housing 170 may have a shape that is cuboid and/or a rectangular prism, and the plurality of side walls may comprise four side walls. In another non-limiting example, the housing 170 may have a shape that is a triangular prism, and the plurality of side walls may comprise three side walls. Other configurations, such as a hexagonal prism, an n-sided prism, or other three-dimensional shapes, are also contemplated.

In some embodiments, the dampening device 160 may comprise a section of compliant tubing 162 extending through the housing 170 between the inlet 174 and the outlet 176. The section of compliant tubing 162 may comprise a lumen extending therein and/or therethrough. The section of compliant tubing 162 may comprise and/or define a side wall. In some embodiments, the section of compliant tubing 162 may extend from the inlet 174 to the outlet 176. The section of compliant tubing 162 may be in fluid communication with the inlet 174 and the outlet 176. In some embodiments, the section of compliant tubing 162 may be disposed within and/or may extend across the interior volume 172. In some embodiments, the section of compliant tubing 162 may span the interior volume 172. In a preferred configuration, the section of compliant tubing 162 may be formed from a polymeric material and/or an elastomeric material. Other configurations, including composite materials, etc. are also contemplated.

The section of compliant tubing 162 may be configured to radially expand from a first configuration toward and/or to a second configuration, as seen in FIG. 2, in response to oscillations and/or spikes in fluid flow rate and/or fluid pressure within the lumen of the section of compliant tubing 162 produced by the fluid pump 110 to smooth out pulsatile fluid flow flowing therein and/or therethrough. The section of compliant tubing 162 may be configured to elastically contract toward and/or to the first configuration when oscillations and/or spikes in the fluid flow rate and/or fluid pressure within the lumen of the section of compliant tubing 162 subside. In some embodiments, the section of compliant tubing 162 may be configured to cooperate with the housing 170 and/or the interior volume 172 to smooth oscillations and/or spikes in fluid flow rate and/or fluid pressure of fluid flowing through the section of compliant tubing 162, wherein elastic and/or compliant characteristic(s) of the section of compliant tubing 162 permit the section of compliant tubing 162 to expand within the housing 170 when there is sufficient interior volume 172 to do so.

In some embodiments, a first portion of the housing 170 may be movable relative to a second portion of the housing 170 to vary fluid flow characteristics (e.g., fluid flow rate, fluid pressure, flow responsiveness, etc.) within the section of compliant tubing 162. In some embodiments, the first portion of the housing 170 may be the side wall 182 and/or the plurality of side walls (e.g., one side wall of the plurality of side walls, two or more side walls of the plurality of side walls (but less than all of the side walls), all side walls or each side wall of the plurality of side walls, etc.). In some embodiments, the second portion of the housing 170 may be the first end wall 178 and/or the second end wall 180. In some embodiments, the first portion of the housing 170 may be movable relative to the second portion of the housing 170 to change the interior volume 172. In some embodiments, the first portion of the housing 170 may be movable relative to the second portion of the housing 170 to reduce and/or shrink the interior volume 172. In some embodiments, the first portion of the housing 170 may be movable relative to the second portion of the housing 170 to increase the interior volume 172.

In some embodiments, the first portion of the housing 170 may be movable between a first position spaced apart from the section of compliant tubing 162 and corresponding to a smooth flow mode of the dampening device 160, as shown in FIG. 2, and a second position disposed immediately adjacent the section of compliant tubing 162 and corresponding to a responsive flow mode, as shown in FIG. 3. In some embodiments, the first portion of the housing 170 may be movable between the first position and the second position to change the interior volume 172. In some embodiments, the first portion of the housing 170 may be movable from the first position toward and/or to the second position to reduce and/or shrink the interior volume 172. In at least some embodiments, in the second position, the first portion of the housing 170 may be configured to prevent radial expansion of the section of compliant tubing 162 in response to oscillations and/or spikes in fluid flow rate and/or fluid pressure within the lumen of the section of compliant tubing 162. In some embodiments, the first portion of the housing 170 may be movable from the second position toward and/or to the first position to increase the interior volume 172. In some embodiments, the side wall 182 and/or the plurality of side walls of the housing 170 may form a radially movable iris surrounding the section of compliant tubing 162 and/or the interior volume 172.

In some embodiments, the dampening device 160 may comprise an actuation mechanism 184 configured to move the first portion of the housing 170 relative to the second portion of the housing 170. In some embodiments, the actuation mechanism 184 may be operatively coupled to the housing 170. In some embodiments, the actuation mechanism 184 may be contained within the housing 170. In some embodiments, the actuation mechanism 184 may be attached directly to the housing 170. Other configurations are also contemplated. For case of understanding, the actuation mechanism 184 is shown in FIGS. 2-3 schematically coupled to the housing 170 via line 185. The skilled artisan will recognize that the line 185 may be considered to represent any of the above-referenced configurations of the actuation mechanism 184 with respect to the housing 170, even though specifics thereof are not expressly illustrated.

In some embodiments, the actuation mechanism 184 may comprise a mechanical actuation mechanism. In some embodiments, the actuation mechanism 184 may comprise a motor, such as a stepper motor, a servo motor, etc. Other configurations are also contemplated. In some embodiments, the actuation mechanism 184 may be configured to move the side wall 182 and/or the plurality of side walls relative to the first end wall 178 and/or the second end wall 180. In some embodiments, the actuation mechanism 184 may be configured to move the plurality of side walls relative to each other. In at least some embodiments, the actuation mechanism 184 may be operatively coupled to and/or in electronic communication with the controller 150. In some embodiments, the actuation mechanism 184 may be responsive to commands sent by the controller 150. In some embodiments, the actuation mechanism 184 may be self-contained, autonomous, and/or independent of the controller 150. Other configurations are also contemplated.

In some embodiments, the housing 170, the side wall 182, and/or the plurality of side walls may be substantially rigid. For the purpose of this disclosure, substantially rigid should be understood to mean non-deflectable and/or non-deformable under normal fluid flow characteristics (e.g., fluid flow rate and/or fluid pressure) found within the system 100, the housing 170, and/or the section of compliant tubing 162. Accordingly, when oscillations and/or spikes in fluid flow rate and/or fluid pressure occur within the system 100, the inflow line 120, and/or the section of compliant tubing 162, the housing 170, the side wall 182, and/or the plurality of side walls may be configured to resist and/or prevent radial expansion of the section of compliant tubing 162 disposed and/or extending therein when the first portion (e.g. the side wall 182, the plurality of side walls, etc.) of the housing 170 is disposed in the second position. In some embodiments, the housing 170 and/or elements thereof may be formed from a rigid material. Some suitable but non-limiting materials for the housing 170, the side wall 182, the first end wall 178, the second end wall 180, the plurality of side walls, etc., including but not limited to polymeric materials, metallic materials, and/or composite materials, are described below.

In some embodiments, the dampening device 160 and/or the section of compliant tubing 162 may be disposed inline with the inflow line 120 of the system 100 and/or the fluid management system extending between the fluid pump 110 and the endoscope 140. For example, the dampening device 160 may be installed and/or fluidly connected between two adjacent portions of the inflow line 120. In one alternative configuration, the dampening device 160 may be disposed at a proximal end and/or at an inlet port of the endoscope 140. In another alternative configuration, the dampening device 160 may be disposed at a distal end and/or at an outlet of the fluid pump 110. In some embodiments, the inlet 174 of the housing 170 may comprise a first coupling element (e.g., an inlet port, a Luer connector, etc.) configured to engage the inflow line 120 and/or a first portion of the inflow line 120. In some embodiments, the outlet 176 of the housing 170 may comprise a second coupling element (e.g., an outlet port, a Luer connector, etc.) configured to engage the inflow line 120 and/or a second portion of the inflow line 120. Other configurations are also contemplated.

In some embodiments, the section of compliant tubing 162 may be the inflow line 120 of the system 100 and/or the fluid management system extending between the fluid pump 110 and the endoscope 140. In some embodiments, the housing 170 may be installed over and/or around the inflow line 120 such that the inflow line 120 forms and/or is the section of compliant tubing 162 extending between the inlet 174 and the outlet 176 of the housing 170. In some embodiments, the inlet 174 and/or the outlet 176 of the housing 170 may be configured to form a fluid tight seal with the inflow line 120. In some embodiments, the housing 170 may be formed in two halves (e.g., a first half and a second half) configured to mate and/or couple together around the section of compliant tubing 162 and/or the inflow line 120. In some embodiments, the first half may be pivotably coupled to the second half in a clam shell arrangement. In some embodiments, the first half may be configured to separate from and/or couple with the second half as desired. For example, the first half may be disposed within and/or formed as a part of a main body of a fluid management system and the second half may be disposed within and/or formed as a part of a door of the fluid management system, wherein the door may be opened and/or removed from the main body to access components therein. Closing and/or attaching the door to the main body may couple the first half of the housing 170 to the second half of the housing 170. In some embodiments, the first half and the second half may be configured to be releasably locked together using mechanical means such as, but not limited to, a snap fit, mechanical latches, etc. Other configurations are also contemplated.

In some embodiments, a method of smoothing a pulsatile fluid flow produced by the fluid pump 110 may comprise coupling the dampening device 160 to the inflow line 120 of the system 100 and/or the fluid management system extending downstream from the fluid pump 110. In some embodiments, the method of smoothing the pulsatile fluid flow produced by the fluid pump 110 may comprise activating the fluid pump 110, thereby causing the pulsatile fluid flow to flow through the inflow line 120, wherein the section of compliant tubing 162 radially expands within the housing 170 and/or the interior volume 172 to smooth out the pulsatile fluid flow. In some embodiments, during initial start-up of the system 100 and/or the fluid management system, and/or when activating the fluid pump 110, the housing 170 may be disposed in the second position and/or the dampening device 160 may be in the responsive flow mode.

In some embodiments, the method of smoothing the pulsatile fluid flow produced by the fluid pump 110 may comprise selectively moving the first portion of the housing 170 relative to the second portion of the housing 170, as described herein, to vary fluid flow characteristics (e.g., fluid flow rate, fluid pressure, flow responsiveness, etc.) within the section of compliant tubing 162. In some embodiments, selectively moving the first portion of the housing 170 relative to the second portion of the housing 170 may comprise moving the first portion of the housing 170 toward and/or against an outer surface of the section of compliant tubing 162. In some embodiments, moving the first portion of the housing 170 toward and/or against the outer surface of the section of compliant tubing 162 and/or shifting the dampening device 160 to the responsive flow mode. In some embodiments, selectively moving the first portion of the housing 170 relative to the second portion of the housing 170 may comprise radially collapsing the first portion of the housing 170 toward and/or against the outer surface of the section of compliant tubing 162. In some embodiments, selectively moving the first portion of the housing 170 relative to the second portion of the housing 170 may comprise moving the first portion of the housing 170 from the first position spaced apart from the section of compliant tubing 162 toward and/or to the second position immediately adjacent, against, and/or in contact with the outer surface of the section of compliant tubing 162.

In some embodiments, moving the first portion of the housing 170 toward and/or against the outer surface of the section of compliant tubing 162, and/or from the first position toward and/or to the second position, may prevent the section of compliant tubing 162 from radially expanding within the housing 170 and/or the interior volume 172. In some embodiments, moving the first portion of the housing 170 toward and/or against the outer surface of the section of compliant tubing 162, and/or from the first position toward and/or to the second position, may constrain the section of compliant tubing 162 between and/or within a rigid structure (e.g., the side wall 182 and/or the plurality of side walls), thereby increasing flow responsiveness within and/or through the section of compliant tubing 162 (e.g., the responsive flow mode).

In some embodiments, the controller 150 may be configured to automatically move the first portion of the housing 170 toward and/or against the outer surface of the section of compliant tubing 162, and/or from the first position toward and/or to the second position, in response to fluid flow characteristics (e.g., fluid flow rate, fluid pressure, etc.) within the section of compliant tubing 162. In some embodiments, the controller 150 may be configured to move the first portion of the housing 170 toward and/or against the outer surface of the section of compliant tubing 162, and/or from the first position toward and/or to the second position, in response to actuation of the activation switch 152. In one non-limiting example, a practitioner may wish to deliver a bolus of fluid to the endoscope 140 and/or the patient. Actuation of the activation switch 152 may be configured to and/or may cause the controller 150 to increase pump speed of the fluid pump 110 while also moving the first portion of the housing 170 toward and/or against the outer surface of the section of compliant tubing 162, and/or from the first position toward and/or to the second position, so that the section of compliant tubing 162 is prevented from radially expanding as the fluid flow rate and/or fluid pressure increases, thereby more quickly delivering the bolus of fluid (e.g., shifting to the responsive mode of the dampening device 160).

In some embodiments, when the activation switch 152 is released, and/or after a predetermined amount of time, the controller may be configured to decrease the pump speed of the fluid pump 110 (e.g., return the fluid pump 110 to its pre-bolus pump speed) while moving the first portion of the housing 170 away from the outer surface of the section of compliant tubing 162 and/or from the second position toward and/or to the first position, thereby permitting the section of compliant tubing 162 to radially expand within the housing 170 in response to fluid flow characteristics (e.g., fluid flow rate, fluid pressure, etc.) within the section of compliant tubing 162 to smooth the pulsatile fluid flow produced by the fluid pump 110. In this manner, the dampening device 160 may be configured to automatically transition from the responsive flow mode toward and/or to the smooth flow mode.

FIG. 3A illustrates selected aspects of an alternative configuration of the dampening device 160. In some embodiments, it may be desirable to stop a bolus of fluid from passing through to the patient, or to significantly reduce the bolus of fluid that does pass through to the patient. In some embodiments, the actuation mechanism 184 may be configured to substantially and/or completely close off the section of compliant tubing 162 at and/or proximate the outlet 176 of the housing 170. In some embodiments, this may be accomplished by tapering the side wall 182 and/or the plurality of side walls radially inward in a distal direction (e.g., toward the outlet 176), as shown in FIG. 3A. Doing so may cause a “bubble” of fluid pressure to build up within the section of compliant tubing 162 and/or the housing 170. In some embodiments, the fluid pump 110 may be reversed to relieve the “bubble” of fluid pressure within the section of compliant tubing 162 and/or the housing 170. In some embodiments, such a reversal may be very short in duration and/or may have minimal impact or no impact on the user and/or the patient. In some alternative configurations, the dampening device 160 and/or the housing 170 may comprise a pressure relief valve (not shown) instead of or in addition to reversing the fluid pump 110. In some embodiments, as the “bubble” of fluid pressure within the section of compliant tubing 162 and/or the housing 170 is relieved and/or removed, the actuation mechanism 184 may be configured to shift the side wall 182 and/or the plurality of side walls radially inward adjacent the inlet 174 so as to shift the first portion of the housing 170 toward and/or to the second position (e.g., FIG. 3). Other configurations are also contemplated.

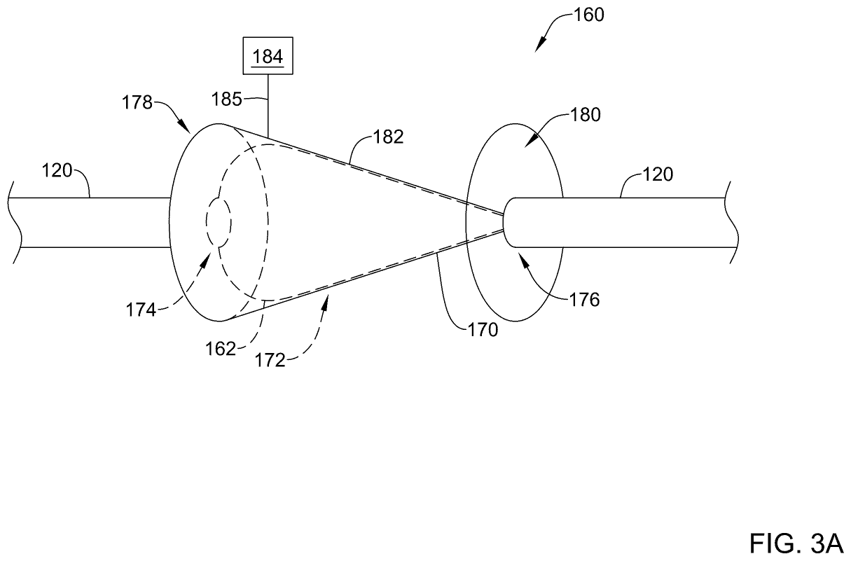

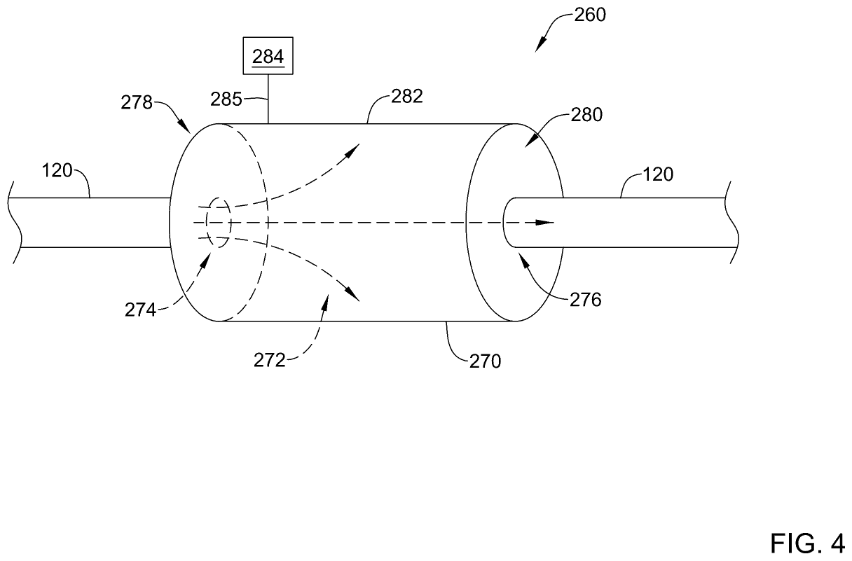

FIGS. 4-5 illustrates selected aspects of the dampening device 260. In some embodiments, the dampening device 260 may comprise a housing 270. The housing 270 may define an interior volume 272 and/or an interior space disposed therein. In some embodiments, the housing 270 may comprise an inlet 274 and an outlet 276. In some embodiments, the housing 270 may comprise a first end wall 278 and a second end wall 280. In some embodiments, the second end wall 280 may be disposed generally opposite the first end wall 278. Other configurations are also contemplated. In some embodiments, the inlet 274 may be disposed in and/or may extend through the first end wall 278. In some embodiments, the outlet 276 may be disposed in and/or may extend through the second end wall 280. The inlet 274 and the outlet 276 may be in fluid communication with the interior volume 272 of the housing 270.

In some embodiments, the housing 270 may comprise a side wall 282 extending between the first end wall 278 and the second end wall 280. In some embodiments, the side wall 282 may extend from the first end wall 278 to the second end wall 280. In some embodiments, the side wall 282 may be substantially annular in shape and/or may extend along and/or around a circumference of the housing 270. As such, the housing 270 may be cylindrical in shape. Other shapes and/or configurations are also contemplated. In some embodiments, the housing 270 may comprise a plurality of side walls extending between the first end wall 278 and the second end wall 280 and/or extending from the first end wall 278 to the second end wall 280. In one non-limiting example, the housing 270 may have a shape that is cuboid and/or a rectangular prism, and the plurality of side walls may comprise four side walls. In another non-limiting example, the housing 270 may have a shape that is a triangular prism, and the plurality of side walls may comprise three side walls. Other configurations, such as a hexagonal prism, an n-sided prism, or other three-dimensional shapes, are also contemplated.

The housing 270 and/or the interior volume 272 may be configured to radially expand and/or contract between a first configuration and a second configuration in response to oscillations and/or spikes in fluid flow rate and/or fluid pressure within the housing 270, the interior volume 272, and/or the inflow line 120 produced by the fluid pump 110 to smooth out pulsatile fluid flow flowing therein and/or therethrough. In some embodiments, the housing 270 may be configured to smooth oscillations and/or spikes in fluid flow rate and/or fluid pressure of fluid flowing through the housing 270, the interior volume 272, and/or the inflow line 120. In some embodiments, the housing 270 may be controlled via a feedback loop, sensor inputs, etc.

In some embodiments, a first portion of the housing 270 may be movable relative to a second portion of the housing 270 to vary fluid flow characteristics (e.g., fluid flow rate, fluid pressure, flow responsiveness, etc.) within the housing 270, the interior volume 272, and/or the inflow line 120. In some embodiments, the first portion of the housing 270 may be the side wall 282 and/or the plurality of side walls (e.g., one side wall of the plurality of side walls, two or more side walls of the plurality of side walls (but less than all of the side walls), all side walls or each side wall of the plurality of side walls, etc.). In some embodiments, the second portion of the housing 270 may be the first end wall 278 and/or the second end wall 280. In some embodiments, the first portion of the housing 270 may be movable relative to the second portion of the housing 270 to change the interior volume 272. In some embodiments, the first portion of the housing 270 may be movable relative to the second portion of the housing 270 to reduce and/or shrink the interior volume 272. In some embodiments, the first portion of the housing 270 may be movable relative to the second portion of the housing 270 to increase the interior volume 272.

In some embodiments, the first portion of the housing 270 may be movable between a first position spaced apart from the inlet 274 and the outlet 276, as shown in FIG. 4, and a second position disposed immediately adjacent the inlet 274 and the outlet 276, as shown in FIG. 5. In some embodiments, the first portion of the housing 270 may be movable between the first position and the second position to change the interior volume 272. In some embodiments, the first portion of the housing 270 may be movable from the first position toward and/or to the second position to reduce and/or shrink the interior volume 272. In some embodiments, the first portion of the housing 270 may be movable from the second position toward and/or to the first position to increase the interior volume 272. In some embodiments, the side wall 282 and/or the plurality of side walls of the housing 270 may form a radially movable iris surrounding the interior volume 272, wherein the side wall 282 and/or the plurality of side walls of the housing 270 may form overlapping segments as the side wall 282 and/or the plurality of side walls shifts, moves, collapses, etc. radially inward toward the second position. Other configurations are also possible.

In some embodiments, the dampening device 260 may comprise an actuation mechanism 284 configured to change the interior volume 272 of the housing 270, thereby changing fluid flow characteristics (e.g., fluid flow rate, fluid pressure, flow responsiveness, etc.) through the housing 270. In some embodiments, the actuation mechanism 284 may be configured to smooth oscillations in fluid flow rate and/or fluid pressure of fluid flowing through the housing 270 by changing the interior volume 272.

In some embodiments, the actuation mechanism 284 may be configured to change the interior volume 272 in response to fluid pressure. In some embodiments, the actuation mechanism 284 may be configured to change the interior volume 272 in response to fluid pressure within the housing 270. In some embodiments, the actuation mechanism 284 may be configured to change the interior volume 272 in response to fluid pressure within the inflow line 120. In some embodiments, the actuation mechanism 284 may be configured to change the interior volume 272 in response to fluid pressure leaving the fluid pump 110. In some embodiments, the actuation mechanism 284 may be configured to change the interior volume 272 in response to each pressure pulse produced by the fluid pump 110.

In some embodiments, the actuation mechanism 284 may be configured to change the interior volume 272 in response to fluid flow rate. In some embodiments, the actuation mechanism 284 may be configured to change the interior volume 272 in response to fluid flow rate within the housing 270. In some embodiments, the actuation mechanism 284 may be configured to change the interior volume 272 in response to fluid flow rate within the inflow line 120. In some embodiments, the actuation mechanism 284 may be configured to change the interior volume 272 in response to fluid flow rate leaving the fluid pump 110. Other configurations are also contemplated.

In some embodiments, the actuation mechanism 284 may be configured to change the interior volume 272 at a frequency equal to a frequency of the fluid pump 110. For example, the fluid pump 110 may operate at a selected frequency such that the fluid pump 110 produces fluid flow in pulses. Each pulse may have an accompanying oscillation and/or spike in fluid flow rate and/or fluid pressure. The actuation mechanism 284 may be configured to operate and/or change the interior volume 272 of the housing 270 at the same frequency as the fluid pump 110 (e.g., the actuation mechanism 284 actuates with each pulse from the fluid pump 110). In at least some embodiments, the frequency of the actuation mechanism 284 may be phase shifted from and/or out of phase with the frequency of the fluid pump 110. As the fluid pump 110 operates, a short time delay may occur before each pulse from the fluid pump 110 reaches the dampening device 260. Accordingly, the actuation mechanism 284 may change the interior volume 272 at a delay from the operation of the fluid pump 110 to align the change in interior volume 272 with the arrival of the pulse from the fluid pump 110.

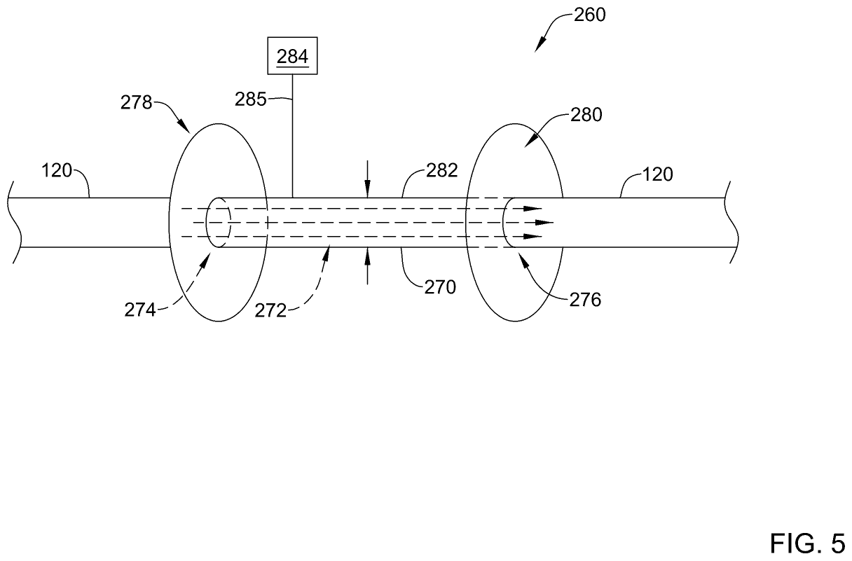

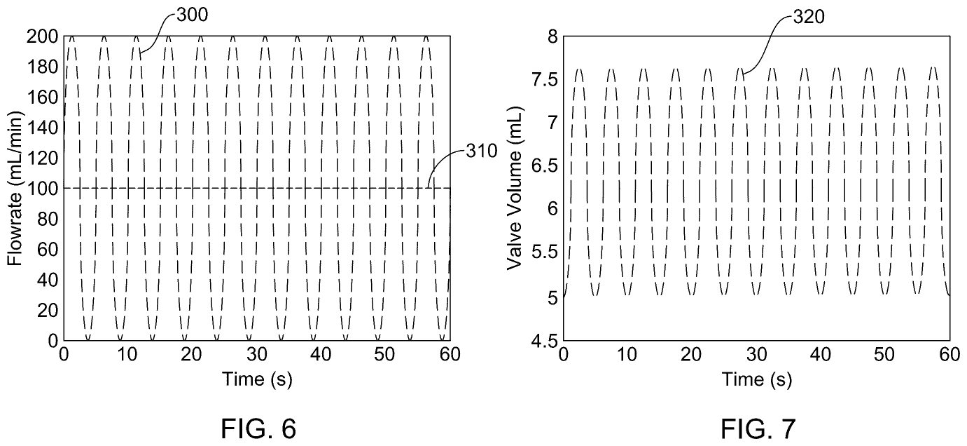

This may be further understood from FIGS. 6-7, which illustrate via charts how the changing interior volume (ref. 320) may be correlated to and/or phase shifted from the flow rate pulses (and/or the fluid pressure pulses). For the purpose of discussion, fluid flow rate into the dampening device 260 may be designated Q1 and fluid flow rate out of the dampening device 260 may be designated Q2. If the interior volume 272 is fixed, Q1=Q2. If the interior volume 272 is increasing, Q1>Q2. If the interior volume 272 is shrinking, Q1<Q2. Conservation of volume implies dV/dt=Q1−Q2, wherein dV is the change in the interior volume 272 and dt is the change in time. With the dampening device 260, the interior volume 272 may be controlled mechanically and/or automatically in response to fluid flow rate, fluid pressure, etc. In some embodiments, the interior volume 272 may be controlled via firmware to align the frequency of the changing interior volume with the frequency of the fluid pump 110. In some embodiments, the firmware may be governed through a combination of mathematical modeling and pressure sensing at the fluid pump 110 and/or the interior volume 272.

As an example only, a control loop to smooth fluid flow rate and/or fluid pressure by mechanically modifying the housing 270 and/or the interior volume 272 may use and/or be based upon the following equation:

$$dV / dt = ( Ppump - P ) / R - Q 2$$

In this equation, Ppump is fluid pressure measured at the fluid pump 110, P is fluid pressure at the housing 270, R is a known flow resistance between the fluid pump 110 and the dampening device 260, and Q2 is the desired fluid flow rate exiting the dampening device 260. The interior volume 272 over time may thus be calculated to smooth the fluid flow. FIGS. 6-7 illustrate an example configuration using certain assumptions. In FIG. 6, the incoming flow rate Q1 (ref. 310) corresponds to the fluid flow rate coming into the dampening device 260, and the outgoing flow rate Q2 (ref. 320) corresponds to the desired smooth fluid flow rate exiting the dampening device 260.

In FIGS. 6-7, the interior volume 272 (e.g., ref. 320) is assumed to begin at 5 milliliters. The fluid flow rate into the dampening device 260 (e.g., Q1) is assumed to follow a prescribed sinusoidal pattern over time (e.g., ref, 300), and the desired fluid flow rate (smoothed) exiting the dampening device 260 is 100 milliliters per minute (e.g., Q2; ref. 310). In this particular example, which illustrates a high flow, highly oscillatory scenario, modifying the interior volume 272 (e.g., dV; ref. 320) by 2.5 milliliters is enough to dampen and/or smooth the oscillations in fluid flow rate and/or fluid pressure.

Returning now to FIGS. 4-5, in some embodiments, the actuation mechanism 284 may be configured to move the first portion of the housing 270 relative to the second portion of the housing 270 to change the interior volume 272. In some embodiments, the actuation mechanism 284 may be operatively coupled to the housing 270. In some embodiments, the actuation mechanism 284 may be contained within the housing 270. In some embodiments, the actuation mechanism 284 may be attached directly to the housing 270. Other configurations are also contemplated. For case of understanding, the actuation mechanism 284 is shown in FIGS. 4-5 schematically coupled to the housing 270 via line 285. The skilled artisan will recognize that the line 285 may be considered to represent any of the above-referenced configurations of the actuation mechanism 284 with respect to the housing 270, even though specifics thereof are not expressly illustrated.

In some embodiments, the actuation mechanism 284 may comprise a mechanical actuation mechanism. In some embodiments, the actuation mechanism 284 may comprise a motor, such as a stepper motor, a servo motor, etc. Other configurations are also contemplated. In some embodiments, the actuation mechanism 284 may be configured to move the side wall 282 and/or the plurality of side walls relative to the first end wall 278 and/or the second end wall 280. In some embodiments, the actuation mechanism 284 may be configured to move the plurality of side walls relative to each other. In at least some embodiments, the actuation mechanism 284 may be operatively coupled to and/or in electronic communication with the controller 150. In some embodiments, the actuation mechanism 284 may be responsive to commands sent by the controller 150. In some embodiments, the actuation mechanism 284 may be self-contained, autonomous, and/or independent of the controller 150. Other configurations are also contemplated.

In some embodiments, the housing 270, the side wall 282, and/or the plurality of side walls may be substantially rigid. For the purpose of this disclosure, substantially rigid should be understood to mean non-deflectable and/or non-deformable under normal fluid flow characteristics (e.g., fluid flow rate and/or fluid pressure) found within the system 100 and/or the housing 270. In some embodiments, the housing 270 may be configured such that fluid flow and/or fluid pressure within the interior volume 272 is prevented from deforming the housing 270. Accordingly, when oscillations and/or spikes in fluid flow rate and/or fluid pressure occur within the system 100, the housing 270, and/or the inflow line 120, the housing 270, the side wall 282, and/or the plurality of side walls may be configured to resist and/or prevent deformation of the housing 270 and/or elements thereof. In some embodiments, the housing 270 and/or elements thereof may be formed from a rigid material. Some suitable but non-limiting materials for the housing 270, the side wall 282, the first end wall 278, the second end wall 280, the plurality of side walls, etc., including but not limited to polymeric materials, metallic materials, and/or composite materials, are described below.

In some embodiments, the dampening device 260 and/or the housing 270 may be disposed inline with the inflow line 120 of the system 100 and/or the fluid management system extending between the fluid pump 110 and the endoscope 140. For example, the dampening device 260 and/or the housing 270 may be installed and/or fluidly connected between two adjacent portions of the inflow line 120. In one alternative configuration, the dampening device 260 and/or the housing 270 may be disposed at a proximal end and/or at an inlet port of the endoscope 140. In another alternative configuration, the dampening device 260 and/or the housing 270 may be disposed at a distal end and/or at an outlet of the fluid pump 110. In some embodiments, the inlet 274 of the housing 270 may comprise a first coupling element (e.g., an inlet port, a Luer connector, etc.) configured to engage the inflow line 120 and/or a first portion of the inflow line 120. In some embodiments, the outlet 276 of the housing 270 may comprise a second coupling element (e.g., an outlet port, a Luer connector, etc.) configured to engage the inflow line 120 and/or a second portion of the inflow line 120. Other configurations are also contemplated. In some embodiments, the inlet 274 and/or the outlet 276 of the housing 270 may be configured to form a fluid tight seal with the inflow line 120.

In some embodiments, a method of smoothing a pulsatile fluid flow produced by the fluid pump 110 may comprise coupling the dampening device 260 to the inflow line 120 of the system 100 and/or the fluid management system extending downstream from the fluid pump 110. In some embodiments, the method of smoothing the pulsatile fluid flow produced by the fluid pump 110 may comprise activating the fluid pump 110, thereby causing the pulsatile fluid flow to flow through the inflow line 120, wherein the housing 270 and/or the interior volume 272 is configured to smooth out the pulsatile fluid flow. In some embodiments, the method of smoothing the pulsatile fluid flow produced by the fluid pump 110 may comprise selectively moving the first portion of the housing 270 relative to the second portion of the housing 270, as described herein, to vary fluid flow characteristics (e.g., fluid flow rate, fluid pressure, flow responsiveness, etc.) within the housing 270.

In some embodiments, selectively moving the first portion of the housing 270 relative to the second portion of the housing 270 may comprise automatically moving the first portion of the housing 270 toward and/or adjacent to the inlet 274 and the outlet 276. In some embodiments, selectively moving the first portion of the housing 270 relative to the second portion of the housing 270 may comprise radially collapsing the first portion of the housing 270 toward and/or adjacent to the inlet 274 and the outlet 276. In some embodiments, selectively moving the first portion of the housing 270 relative to the second portion of the housing 270 may comprise moving the first portion of the housing 270 from the first position spaced apart from the inlet 274 and the outlet 276 toward and/or to the second position adjacent to the inlet 274 and the outlet 276.

In some embodiments, moving the first portion of the housing 270 toward and/or adjacent to the inlet 274 and the outlet 276, and/or from the first position toward and/or to the second position, may prevent fluid flow from dispersing within the housing 270 and/or the interior volume 272 to smooth out the pulsatile flow. In some embodiments, moving the first portion of the housing 270 toward and/or adjacent to the inlet 274 and the outlet 276, and/or from the first position toward and/or to the second position, may constrain fluid flow within a rigid structure (e.g., the side wall 182 and/or the plurality of side walls), thereby increasing flow responsiveness within and/or through the housing 270.

In some embodiments, the controller 150 may be configured to automatically move the first portion of the housing 270 toward and/or adjacent to the inlet 274 and the outlet 276, and/or from the first position toward and/or to the second position, in response to fluid flow characteristics (e.g., fluid flow rate, fluid pressure, etc.) within the housing 270. In some embodiments, the controller 150 may be configured to automatically move the first portion of the housing 270 toward and/or adjacent to the inlet 274 and the outlet 276, and/or from the first position toward and/or to the second position, in response to pulses produced by the fluid pump 110.

In some embodiments, the controller 150 may be configured to move the first portion of the housing 270 toward and/or adjacent to the inlet 274 and the outlet 276, and/or from the first position toward and/or to the second position, in response to actuation of the activation switch 152. In one non-limiting example, a practitioner may wish to deliver a bolus of fluid to the endoscope 140 and/or the patient. Actuation of the activation switch 152 may be configured to and/or may cause the controller 150 to increase pump speed of the fluid pump 110 while also moving the first portion of the housing 270 toward and/or adjacent to the inlet 274 and the outlet 276, and/or from the first position toward and/or to the second position, so that the fluid flow is prevented from dispersing within the housing 270 and/or the interior volume 272 as the fluid flow rate and/or fluid pressure increases, thereby more quickly delivering the bolus of fluid. When the activation switch 152 is released, and/or after a predetermined amount of time, the controller may be configured to decrease the pump speed of the fluid pump 110 (e.g., return the fluid pump 110 to its pre-bolus pump speed) while moving the first portion of the housing 270 away from the inlet 274 and the outlet 276 and/or from the second position toward and/or to the first position, thereby permitting fluid flow to disperse within the housing 270 and/or the interior volume 272 to smooth the pulsatile fluid flow produced by the fluid pump 110.

In some embodiments, the controller 150 may be configured to automatically move the first portion of the housing 270 relative to the inlet 274 and the outlet 276, and/or between the first position and the second position, in response to operation of the fluid pump 110 and/or pulses produced by the fluid pump 110. In some embodiments, the controller 150 may be configured to automatically move the first portion of the housing 270 relative to the inlet 274 and the outlet 276, and/or between the first position and the second position, at the same frequency as the fluid pump 110 and/or at the same frequency as pulses produced by the fluid pump 110. In some embodiments, the controller 150 may be configured to automatically move the first portion of the housing 270 relative to the inlet 274 and the outlet 276, and/or between the first position and the second position, out of phase with and/or phase shifted with respect to operation of the fluid pump 110 and/or pulses produced by the fluid pump 110. Other configurations are also contemplated.

The materials that can be used for the various components of the system (and/or other elements disclosed herein) and the various components thereof disclosed herein may include those commonly associated with medical devices and/or systems. For simplicity purposes, the following discussion refers to the system. However, this is not intended to limit the devices and methods described herein, as the discussion may be applied to other elements, members, components, or devices disclosed herein, such as, but not limited to, the fluid pump, the fluid management system, the inflow tubing, the endoscope, the housing, the compliant tubing, etc. and/or elements or components thereof.

In some embodiments, the system and/or components thereof may be made from a metal, metal alloy, polymer (some examples of which are disclosed below), a metal-polymer composite, ceramics, combinations thereof, and the like, or other suitable material.

Some examples of suitable polymers may include polytetrafluoroethylene (PTFE), ethylene tetrafluoroethylene (ETFE), fluorinated ethylene propylene (FEP), polyoxymethylene (POM; for example, DELRIN®), polyether block ester, polyurethane, polypropylene (PP), polyvinylchloride (PVC), polyether-ester (for example, ARNITEL®), ether or ester based copolymers (for example, butylene/poly(alkylene ether) phthalate and/or other polyester elastomers such as HYTREL®), polyamide (for example, DURETHAN® or CRISTAMID®), elastomeric polyamides, block polyamide/ethers, polyether block amide (PEBA; for example, PEBAX®), ethylene vinyl acetate copolymers (EVA), silicones, polyethylene (PE), MARLEX® high-density polyethylene, MARLEX® low-density polyethylene, linear low density polyethylene (for example, REXELL®), polyester, polybutylene terephthalate (PBT), polyethylene terephthalate (PET), polytrimethylene terephthalate, polyethylene naphthalate (PEN), polyetheretherketone (PEEK), polyimide (PI), polyetherimide (PEI), polyphenylene sulfide (PPS), polyphenylene oxide (PPO), poly paraphenylene terephthalamide (for example, KEVLAR®), polysulfone, nylon, nylon-12 (such as GRILAMID®), perfluoro (propyl vinyl ether) (PFA), ethylene vinyl alcohol, polyolefin, polystyrene, acrylonitrile butadiene styrene (ABS), epoxy, polyvinylidene chloride (PVdC), poly(styrene-b-isobutylene-b-styrene) (for example, SIBS and/or SIBS 50A), polycarbonates, polyurethane silicone copolymers (for example, Elast-Eon® or ChronoSil®), biocompatible polymers, other suitable materials, or mixtures, combinations, copolymers thereof, polymer/metal composites, and the like. In some embodiments, the system and/or components thereof can be blended with a liquid crystal polymer (LCP). For example, the mixture can contain up to about 6 percent LCP.

Some examples of suitable metals and metal alloys include stainless steel, such as 304 and/or 316 stainless steel and/or variations thereof; mild steel; nickel-titanium alloy such as linear-elastic and/or super-elastic nitinol; other nickel alloys such as nickel-chromium-molybdenum alloys (e.g., UNS: N06625 such as INCONEL® 625, UNS: N06022 such as HASTELLOY® C-22®, UNS: N10276 such as HASTELLOY® C276®, other HASTELLOY® alloys, and the like), nickel-copper alloys (e.g., UNS: N04400 such as MONEL® 400, NICKELVAC® 400, NICORROS® 400, and the like), nickel-cobalt-chromium-molybdenum alloys (e.g., UNS: R30035 such as MP35-N® and the like), nickel-molybdenum alloys (e.g., UNS: N10665 such as HASTELLOY® ALLOY B2®), other nickel-chromium alloys, other nickel-molybdenum alloys, other nickel-cobalt alloys, other nickel-iron alloys, other nickel-copper alloys, other nickel-tungsten or tungsten alloys, and the like; cobalt-chromium alloys; cobalt-chromium-molybdenum alloys (e.g., UNS: R30003 such as ELGILOY®, PHYNOX®, and the like); platinum enriched stainless steel; titanium; platinum; palladium; gold; combinations thereof; or any other suitable material.

In at least some embodiments, portions or all of the system and/or components thereof may also be doped with, made of, or otherwise include a radiopaque material. Radiopaque materials are understood to be materials capable of producing a relatively bright image on a fluoroscopy screen or another imaging technique (e.g., ultrasound, etc.) during a medical procedure. This relatively bright image aids the user of the system in determining its location. Some examples of radiopaque materials can include, but are not limited to, gold, platinum, palladium, tantalum, tungsten alloy, polymer material loaded with a radiopaque filler, and the like. Additionally, other radiopaque marker bands and/or coils may also be incorporated into the design of the system to achieve the same result.

In some embodiments, the system and/or components thereof may include a fabric material. The fabric material may be composed of a biocompatible material, such a polymeric material or biomaterial, adapted to promote tissue ingrowth. In some embodiments, the fabric material may include a bioabsorbable material. Some examples of suitable fabric materials include, but are not limited to, polyethylene glycol (PEG), nylon, polytetrafluoroethylene (PTFE, ePTFE), a polyolefinic material such as a polyethylene, a polypropylene, polyester, polyurethane, and/or blends or combinations thereof.

In some embodiments, the system and/or components thereof may include and/or be formed from a textile material. Some examples of suitable textile materials may include synthetic yarns that may be flat, shaped, twisted, textured, pre-shrunk or un-shrunk. Synthetic biocompatible yarns suitable for use in the present disclosure include, but are not limited to, polyesters, including polyethylene terephthalate (PET) polyesters, polypropylenes, polyethylenes, polyurethanes, polyolefins, polyvinyls, polymethylacetates, polyamides, naphthalene dicarboxylene derivatives, natural silk, and polytetrafluoroethylenes. Moreover, at least one of the synthetic yarns may be a metallic yarn or a glass or ceramic yarn or fiber. Useful metallic yarns include those yarns made from or containing stainless steel, platinum, gold, titanium, tantalum or a Ni—Co—Cr-based alloy. The yarns may further include carbon, glass or ceramic fibers. Desirably, the yarns are made from thermoplastic materials including, but not limited to, polyesters, polypropylenes, polyethylenes, polyurethanes, polynaphthalenes, polytetrafluoroethylenes, and the like. The yarns may be of the multifilament, monofilament, or spun types. The type and denier of the yarn chosen may be selected in a manner which forms a biocompatible and implantable prosthesis and, more particularly, a vascular structure having desirable properties.

In some embodiments, the system and/or components thereof may include and/or be treated with a suitable therapeutic agent. Some examples of suitable therapeutic agents may include anti-thrombogenic agents (such as heparin, heparin derivatives, urokinase, and PPack (dextrophenylalanine proline arginine chloromethyl ketone)); anti-proliferative agents (such as enoxaparin, angiopeptin, monoclonal antibodies capable of blocking smooth muscle cell proliferation, hirudin, and acetylsalicylic acid); anti-inflammatory agents (such as dexamethasone, prednisolone, corticosterone, budesonide, estrogen, sulfasalazine, and mesalamine); antineoplastic/antiproliferative/anti-mitotic agents (such as paclitaxel, 5-fluorouracil, cisplatin, vinblastine, vincristine, epothilones, endostatin, angiostatin and thymidine kinase inhibitors); anesthetic agents (such as lidocaine, bupivacaine, and ropivacaine); anti-coagulants (such as D-Phe-Pro-Arg chloromethyl ketone, an RGD peptide-containing compound, heparin, anti-thrombin compounds, platelet receptor antagonists, anti-thrombin antibodies, anti-platelet receptor antibodies, aspirin, prostaglandin inhibitors, platelet inhibitors, and tick antiplatelet peptides); vascular cell growth promoters (such as growth factor inhibitors, growth factor receptor antagonists, transcriptional activators, and translational promoters); vascular cell growth inhibitors (such as growth factor inhibitors, growth factor receptor antagonists, transcriptional repressors, translational repressors, replication inhibitors, inhibitory antibodies, antibodies directed against growth factors, bifunctional molecules consisting of a growth factor and a cytotoxin, bifunctional molecules consisting of an antibody and a cytotoxin); immunosuppressants (such as the “olimus” family of drugs, rapamycin analogues, macrolide antibiotics, biolimus, everolimus, zotarolimus, temsirolimus, picrolimus, novolimus, myolimus, tacrolimus, sirolimus, pimecrolimus, etc.); cholesterol-lowering agents; vasodilating agents; and agents which interfere with endogenous vasoactive mechanisms.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment in other embodiments. The scope of the disclosure is, of course, defined in the language in which the appended claims are expressed.

What is claimed is:

1. A dampening device for use with a fluid management system comprising a fluid pump producing a pulsatile fluid flow, comprising:
a housing comprising an inlet and an outlet; and
a section of compliant tubing extending through the housing between the inlet of the housing and the outlet of the housing;
wherein a first portion of the housing is movable relative to a second portion of the housing to vary fluid flow characteristics within the section of compliant tubing.

2. The dampening device of claim 1, wherein the section of compliant tubing is configured to smooth oscillations in fluid flow rate of fluid flowing through the section of compliant tubing.

3. The dampening device of claim 1, wherein the first portion of the housing is movable between a first position spaced apart from the section of compliant tubing and a second position disposed immediately adjacent the section of compliant tubing.

4. The dampening device of claim 3, wherein in the second position, the first portion of the housing prevents radial expansion of the section of compliant tubing in response to fluid flow oscillations therein.

5. The dampening device of claim 1, wherein the section of compliant tubing is an inflow line of the fluid management system extending between the fluid pump and an endoscope.

6. The dampening device of claim 1, wherein the section of compliant tubing is disposed inline with an inflow line of the fluid management system extending between the fluid pump and an endoscope.

7. The dampening device of claim 1, wherein the first portion of the housing is a side wall extending between a first end wall of the housing and a second end wall of the housing.

8. The dampening device of claim 7, wherein the side wall of the housing forms a radially movable iris surrounding the section of compliant tubing.

9. A dampening device for use with a fluid management system comprising a fluid pump producing a pulsatile fluid flow, comprising:
a housing defining an interior volume, wherein the housing comprises an inlet and an outlet; and
an actuation mechanism configured to change the interior volume thereby changing fluid flow characteristics through the housing.

10. The dampening device of claim 9, wherein the actuation mechanism is configured to smooth oscillations in fluid flow rate of fluid flowing through the housing by changing the interior volume.

11. The dampening device of claim 10, wherein the actuation mechanism is configured to change the interior volume in response to fluid pressure.

12. The dampening device of claim 9, wherein the actuation mechanism is configured to change the interior volume with each pressure pulse produced by the fluid pump.

13. The dampening device of claim 9, wherein the actuation mechanism is configured to change the interior volume at a frequency equal to a frequency of the fluid pump.

14. The dampening device of claim 13, wherein the frequency of the actuation mechanism is phase shifted from the frequency of the fluid pump.

15. The dampening device of claim 9, wherein the housing is configured such that fluid pressure within the interior volume is prevented from deforming the housing.

16. The dampening device of claim 9, wherein a first portion of the housing is movable relative to a second portion of the housing to change the interior volume.

17. A method of smoothing a pulsatile fluid flow produced by a fluid pump, comprising:
coupling a dampening device to an inflow line extending downstream from the fluid pump, wherein the dampening device comprises:
a housing comprising an inlet and an outlet; and
a section of compliant tubing extending through the housing between the inlet of the housing and the outlet of the housing;
activating the fluid pump, thereby causing the pulsatile fluid flow to flow through the inflow line, wherein the section of compliant tubing radially expands within the housing to smooth out the pulsatile fluid flow; and
selectively moving a first portion of the housing relative to a second portion of the housing to vary fluid flow characteristics within the section of compliant tubing.

18. The method of claim 17, wherein selectively moving the first portion of the housing relative to the second portion of the housing comprises moving the first portion of the housing against an outer surface of the section of compliant tubing.

19. The method of claim 18, wherein moving the first portion of the housing against the outer surface of the section of compliant tubing prevents the section of compliant tubing from radially expanding within the housing.

20. The method of claim 17, wherein the housing surrounds the section of compliant tubing.
